(19) United States
(12) Patent Application Publication
(10) Pub. No.: US 2017/0347535 A1
(43) Pub. Date: Dec. 7, 2017

(54) NURSERY POT POSITIONING DEVICE AND METHOD

(71) Applicant: Carl Nunez, Saugus, CA (US)

(72) Inventor: Carl Nunez, Saugus, CA (US)

(21) Appl. No.: 15/174,379

(22) Filed: Jun. 6, 2016

(51) Int. Cl. A01G 9/08; B25J 1/04; A01G 1/00

(52) U.S. Cl. CPC A01G 9/088; A01G 1/001; B25J 1/04

(57) ABSTRACT

A positioning device for a plant container having a lip. The positioning device has an extension arm with a hook rigidly connected at one end and a handle rigidly connected at the other end. The positioning device is utilized to move a plant container by engaging the hook with the plant container's lip and then dragging the plant container to a predetermined position. In a preferred embodiment the plant container is a nursery pot.

The present invention relates to positioning devices, and in particular, to devices used to position nursery pots and plant containers.

### BACKGROUND OF THE INVENTION

Nursery pots are well known and are commonly found in nurseries and other businesses that sell and/or utilize plants. For example, a movie set or television set will typically utilize many heavy plants contained in nursery pots that will need to be positioned as appropriate.

FIG. 7 shows a prior art nursery pot 30 containing large, heavy plant 35. Nursery pot 30 is commonly fabricated from plastic and includes lip 31. Lip 31 is commonly grabbed by the user and utilized to lift nursery pot 30.

The soil and plant inside nursery pot 30 can be very heavy. It is a potential health hazard to lift nursery pot 30, especially if the user is repeated tasked with lifting and maneuvering nursery pot 30. The user can easily damage his back, knees, feet and arms.

What is needed is a better device for positioning nursery pots and similar plant containers.

### SUMMARY OF THE INVENTION

The present invention provides a positioning device for a plant container having a lip. The positioning device has an extension arm with a hook rigidly connected at one end and a handle rigidly connected at the other end. The positioning device is utilized to move a plant container by engaging the hook with the plant container's lip and then dragging the plant container to a predetermined position. In a preferred embodiment the plant container is a nursery pot.

### BRIEF DESCRIPTION OF THE DRAWINGS

FIGS. 1-2 show preferred embodiments of the present invention.

FIGS. 3-6 depict a preferred method for utilizing the present invention.

FIG. 7 shows a prior art nursery pot.

### DETAILED DESCRIPTION OF THE PREFERRED EMBODIMENTS

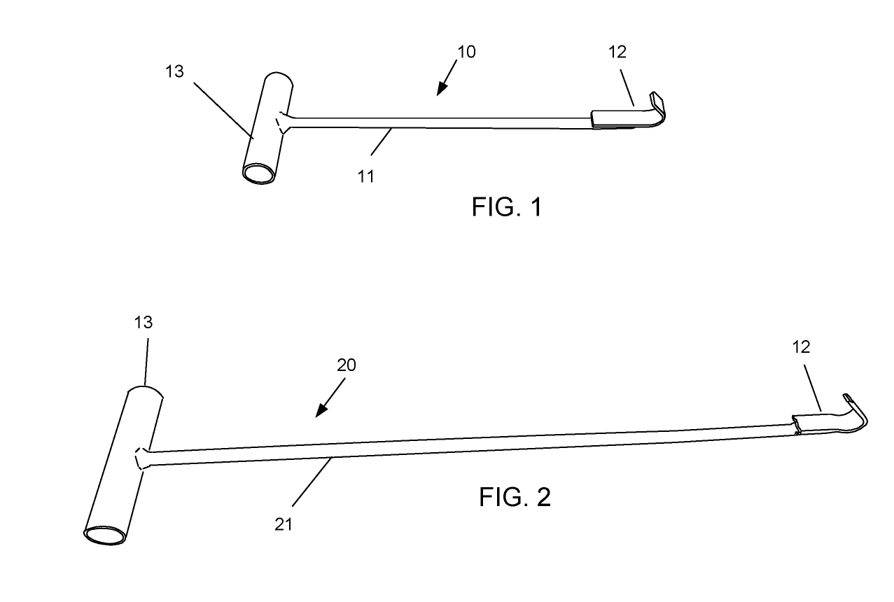

FIGS. 1 and 2 show preferred nursery pot positioning devices 10 and 20. Positioning devices 10 and 20 are identical except for the length of extension arms 11 and 21. The length of the extension arm may be varied depending upon the preferences of the user. For example, in one preferred embodiment extension arm 11 is approximately 20 inches (FIG. 1). In another preferred embodiment handle 21 is approximately 30 inches (FIG. 2).

As shown in FIG. 1, hook 12 is welded to extension arm 11 at one end of extension arm 11. Handle 13 is welded to the opposite end of extension arm 11. As shown in FIG. 2, hook 12 is welded to extension arm 21 at one end of extension arm 21. Handle 13 is welded to the opposite end of extension arm 21.

### Utilization of Nursery Pot Positioning Devices

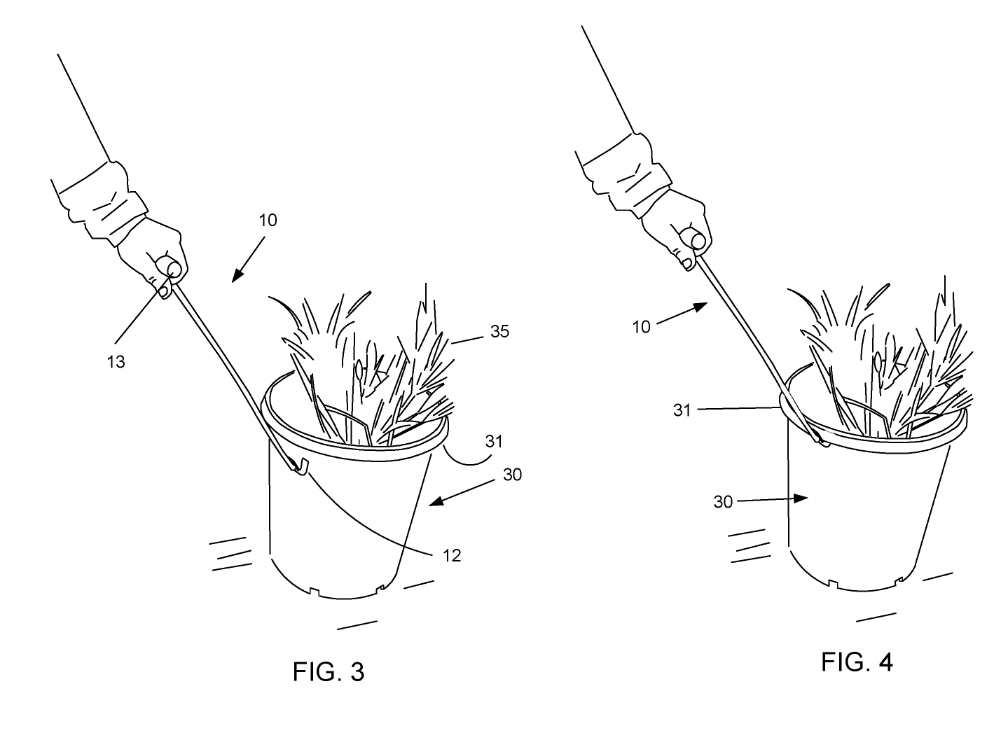

FIGS. 3-6 depict an illustration of the utilization of positioning device 10 to move a heavy nursery pot 30 containing plant 35.

In FIG. 3, the user has grabbed handle 13 and has moved hook 12 so that it is positioned near lip 31 of nursery pot 30.

In FIG. 4, the user has moved hook 12 upward so that it has engaged lip 31 by being between lip 31 and nursery pot 30.

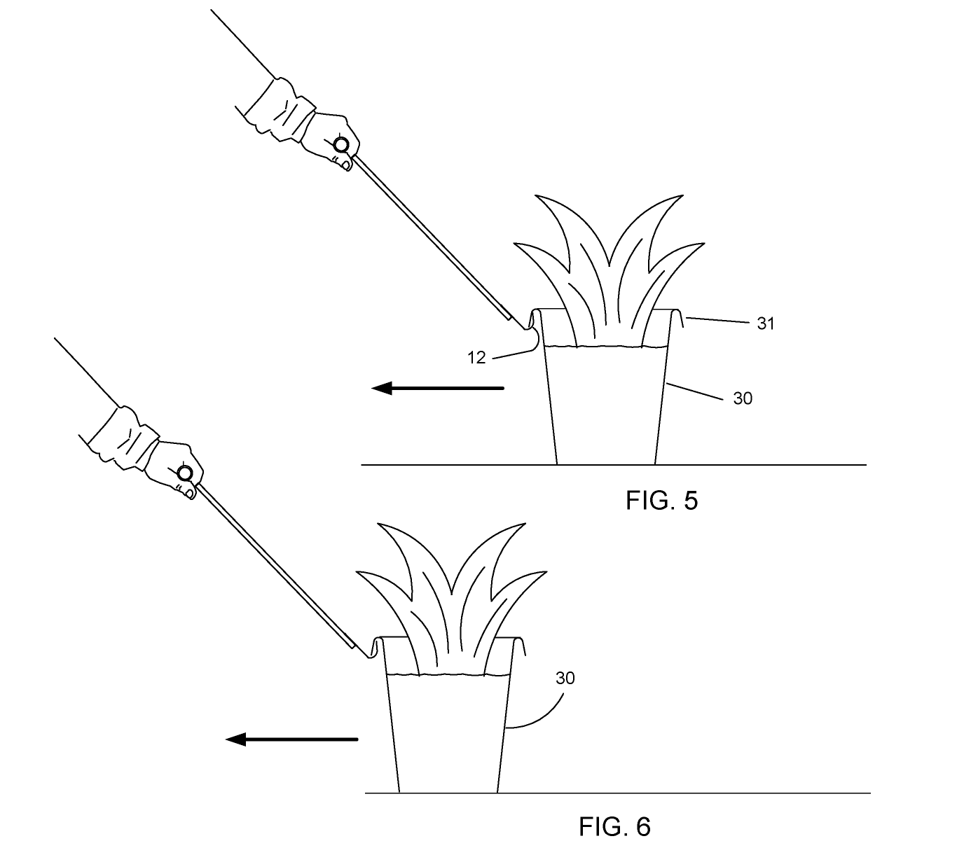

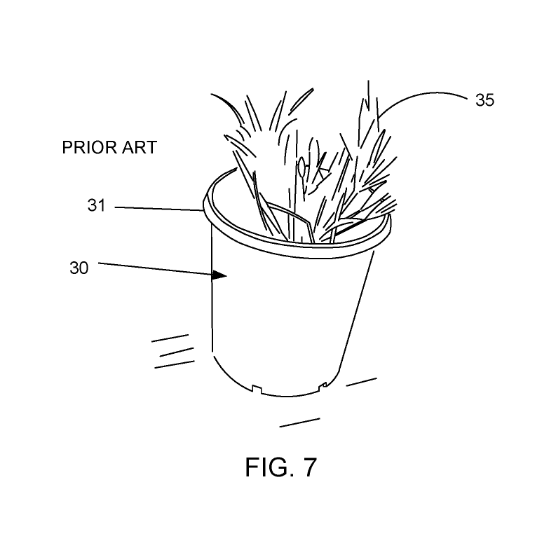

FIG. 5 shows a simplified side view of the image shown in FIG. 4. In FIG. 5 user is beginning to drag nursery pot 30 leftward. In FIG. 6 the user has continued to drag nursery pot 30 leftward.

Although the above-preferred embodiments have been described with specificity, persons skilled in this art will recognize that many changes to the specific embodiments disclosed above could be made without departing from the spirit of the invention. Therefore, the attached claims and their legal equivalents should determine the scope of the invention.

What is claimed is:

1. A positioning device for a plant container with a lip, said positioning device comprising:
A. an extension arm,
B. a hook rigidly connected to said extension arm, and
C. a handle rigidly connected to said extension arm,
wherein said hook is engaged with said lip to move said plant container by dragging said plant container to a predetermined position.

2. The positioning device as in claim 1, wherein said hook and said handle are welded to said extension arm at opposite ends of said extension arm.

3. The positioning device as in claim 1, wherein said hook is engaged with said lip when said hook is between said lip and said plant container.

4. The positioning device as in claim 1, wherein said plant container is a nursery pot.

5. A method for positioning a plant container with a lip, comprising the steps of:
A. grabbing a positioning device, said positioning device comprising:
i. an extension arm,
ii. a hook rigidly connected to said extension arm, and
iii. a handle rigidly connected to said extension arm,
B. engaging said hook with said lip to move said plant container, and
C. dragging said plant container to a predetermined position.

6. The method as in claim 5, wherein said hook and said handle are welded to said extension arm at opposite ends of said extension arm.

7. The method as in claim 5, wherein said hook is engaged with said lip when said hook is between said lip and said plant container.

8. The method as in claim 5, wherein said plant container is a nursery pot.
